(19) United States
(12) Patent Application Publication
(10) Pub. No.: US 2008/0250678 A1
(43) Pub. Date: Oct. 16, 2008

(54) Kits, Methods, and Accessories for Decoratively Reconfiguring and Protecting a Retractable Device

(76) Inventors: Amy M. KRESSER, Sandusky, OH (US); Sue HAIM, Milwaukee, WI (US)

Correspondence Address: HAHN LOESER & PARKS, LLP, One GOJO Plaza, Suite 300, AKRON, OH, 44311-1076, US

(21) Appl. No.: 12/054,630

(22) Filed: Mar. 25, 2008

Related U.S. Application Data
(60) Provisional application No. 60/922,668, filed on Apr. 10, 2007.

(51) Int. Cl. A44C 3/00; B65H 75/48; G09F 3/08; B23P 19/04

(52) U.S. Cl. 40/1.5; 242/379; 29/700; 40/662

(57) ABSTRACT

Kits, methods, and accessories for decoratively reconfiguring and protecting a retractable device. One embodiment of a kit includes a retractable device having a case that houses a retractable cord, a cap capable of being press-fitted onto the case of the retractable device, and a decorative piece capable of being attached to the cap. One embodiment of a method includes positioning a fitted cover, having a first decorative piece attached to an outer surface thereof, directly above a housing of a retractable device, aligning a notch within a side surface of the fitted cover with a port in a side surface of the housing of the retractable device, and press-fitting the cover onto the housing of the retractable device. One embodiment of an accessory includes a fitted cover having a decorative piece, and capable of being press-fitted onto a housing of a user-wearable device.

### CROSS-REFERENCE TO RELATED APPLICATIONS/INCORPORATION BY REFERENCE

This U.S. Patent Application claims priority to and the benefit of U.S. Provisional Patent Application Ser. No. 60/922,668 filed on Apr. 10, 2007 which is incorporated herein by reference in its entirety.

### TECHNICAL FIELD

Certain embodiments relate to protective and decorative covers. More particularly, certain embodiments relate to protective and decorative fitted covers for a retractable device worn by a person, and kits and methods related thereto.

### BACKGROUND

Currently, retractable devices such as, for example, retractable badge reel devices are available with a fixed design or logo imprinted on a surface of a casing or housing of the retractable device. Others have proposed retractable devices with cumbersome billboard implementations and adaptors for displaying designs or logos.

Further limitations and disadvantages of conventional, traditional, and proposed approaches will become apparent to one of skill in the art, through comparison of such approaches with the embodiments as set forth in the remainder of the present application with reference to the drawings.

### BRIEF SUMMARY

A first embodiment comprises a kit including a retractable device having a case that houses a retractable cord. The kit also includes at least one cap capable of being press-fitted onto and subsequently removed from the case of the retractable device a plurality of times. The kit further includes at least one decorative piece capable of being attached to the at least one cap. The retractable device may include the case, the retractable cord housed within the case, a port within a side of the case for the retractable cord to pass through, a bob connected to a proximal end of the retractable cord, and a securing unit connected to the bob for securing a badge thereto, for example. The at least one cap may be substantially cylindrical in shape. A diameter and a height of the substantially cylindrical cap may substantially match a diameter and a height of the case of the retractable device. As an alternative, the at least one cap may be of another shape such as, for example, a square shape, a rectangular shape, or a triangular shape, where the dimensions of the cap substantially match the dimensions of the case of the retractable device. A side of the at least one cap may include a notch to accommodate the retractable cord of the retractable device there through. The at least one decorative piece may include at least one of a decorative button, a bubble sticker, a logo, an icon, a shoe-doodle™ charm, and a Jibbitz® charm. The at least one cap may include a top portion having an opening to accommodate insertion of a shoe-doodle™ charm or a Jibbitz® charm. The at least one plastic cap may be made of a molded plastic material.

Another embodiment comprises a kit including a plurality of fitted covers. Each fitted cover is capable of being press-fitted onto and subsequently removed from a housing of a retractable device a plurality of times. The kit also includes a plurality of decorative pieces. Each decorative piece is capable of being attached to any one of the plurality of fitted covers. The retractable device may include the housing, a retractable cord housed within the housing, a port within a side of the housing for the retractable cord to pass through, a bob connected to a proximal end of the retractable cord, and a securing unit connected to the bob for securing a badge thereto, for example. Each of the plurality of fitted covers may be substantially cylindrical in shape. A diameter and a height of each of the substantially cylindrical fitted covers may substantially match a diameter and a height of the housing of the retractable device. As an alternative, a fitted cover may be of another shape such as, for example, a square shape, a rectangular shape, or a triangular shape, where the dimensions of the fitted cover substantially match the dimensions of the housing of the retractable device. A side of each of the fitted covers may include a notch to accommodate the retractable cord of the retractable device there through. Each of the plurality of decorative pieces may include one of a decorative button, a bubble sticker, a logo, an icon, a shoe-doodle™ charm, and a Jibbitz® charm. At least one of the plurality of fitted covers may include a top portion having an opening to accommodate insertion of a shoe-doodle™ charm or a Jibbitz® charm. Each of the plurality of fitted covers may be made of a molded plastic material.

A further embodiment comprises a method of decoratively reconfiguring and protecting a retractable device. The method includes positioning a first fitted cover, having at least a first decorative piece attached to an outer surface thereof, directly above a housing of the retractable device. The method also includes aligning a notch within a side surface of the first fitted cover with a port in a side surface of the housing of the retractable device and press-fitting the first fitted cover onto the housing of the retractable device. The method may further include slidably removing the first fitted cover from the housing of the retractable device and positioning a second fitted cover, having at least a second decorative piece attached to an outer surface thereof, directly above the housing of the retractable device. The method may also include aligning a notch within a side surface of the second fitted cover with the port in the side surface of the housing of the retractable device and press-fitting the second fitted cover onto the housing of the retractable device. The first fitted cover and the second fitted cover may be made of a molded plastic material.

An additional embodiment comprises a decorative and protective accessory for press-fitting onto a retractable device. The accessory includes a substantially cylindrically shaped plastic cap including a substantially flat top portion having a diameter of about 1.25 inches and a curved wall portion having a height of about 0.375 inches. The accessory further includes at least one decorative piece attached to the top portion of the plastic cap and a notch within the curved wall portion of the plastic cap to accommodate a retractable cord of the retractable device there through. The notch may be about 0.25 inches in width and about 0.25 inches in height. The decorative piece includes one of a decorative button, a bubble sticker, a logo, an icon, a shoe-doodle™ charm, and a Jibbitz® charm.

A further embodiment comprises a decorative and protective accessory for press-fitting onto a housing of a user-wearable device. The accessory includes a fitted cover having a top portion and a wall portion, wherein dimensions of the fitted cover substantially match similar dimensions of the housing of the user-wearable device. The accessory also includes at least one decorative piece attached to the top portion of the fitted cover and, optionally, at least one notch within the wall portion, for example, to accommodate a cord of the user-wearable device there through. The at least one decorative piece may include one of a decorative button, a bubble sticker, a logo, an icon, a shoe-doodle™ charm, and a Jibbitz® charm. The fitted cover may be made of a molded plastic material.

These and other advantages and novel features of embodiments, as well as details of certain illustrated embodiments thereof, will be more fully understood from the following description and drawings.

### BRIEF DESCRIPTION OF THE DRAWINGS

FIGS. 1A-1B illustrate an exemplary embodiment of a retractable device being that of a retractable badge reel;

FIGS. 2A-2C illustrate an exemplary embodiment of a fitted cover or cap for decoratively reconfiguring and protecting the retractable device of FIG. 1;

FIG. 3 illustrates exemplary embodiments of decorative pieces that may be attached to the fitted cover or cap of FIGS. 2A-2C;

FIGS. 4A-4B illustrate an exemplary embodiment of a decorative piece (a Jibbitz® charm) being attached to a fitted cover;

FIGS. 5A-5B illustrate an exemplary embodiment of a process for press-fitting a fitted cover or cap onto a case of the retractable device of FIG. 1;

FIG. 6 illustrates an exemplary embodiment of a decorative fitted cover or cap on a retractable badge reel as worn by a nurse;

FIG. 7 is a flow chart of an exemplary embodiment of a method of decoratively reconfiguring and protecting a retractable device;

FIG. 8 illustrates a first exemplary embodiment of a kit; and

FIG. 9 illustrates a second exemplary embodiment of a kit.

### DETAILED DESCRIPTION

The following description is presented in the context of retractable badge reel devices that are typically worn by employees for securing employee identification and security access badges. However, various embodiments may be applied to other retractable or non-retractable user-wearable devices as well such as, for example, a device for securing a set of keys worn by a janitor.

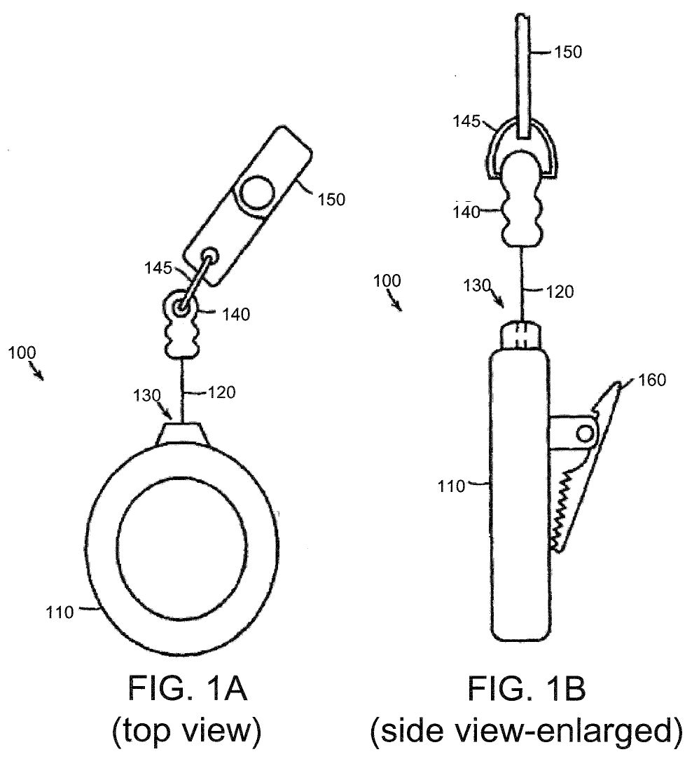

FIGS. 1A-1B illustrate an exemplary embodiment of a retractable device 100 being that of a retractable badge reel. Such retractable badge reels are well known in the art. FIG. 1A is a top view and FIG. 1B is an enlarged side view of the retractable device 100. The retractable device 100 includes a case or housing 110, a retractable cord 120 housed within the case or housing 110, a port 130 within a side of the case or housing 110 for the retractable cord to pass through, a bob 140 connected to a proximal end of the retractable cord 120, and a securing unit 150 connected to the bob 140 for securing a badge thereto. The securing unit 150 may be connected to the bob 140 via a clasp or ring 145, for example. The case or housing 110 is often made of a plastic material.

The retractable device 100 further includes a clip 160 for securing the case or housing 110 to a pocket, lapel, or belt, for example, of a person (a user). A user may pull, for example, an attached identification badge causing the cord 120 to be unwound within the housing 110 and extended out of the housing 110 through the port 140. A user may pull the badge to extend the badge toward a security activation device, for example, to open a secured door. When the user lets go of the badge, the cord 120 automatically retracts back into the housing 110 through the port 130 and is rewound within the housing 110. The bob 140 prevents the proximal end of the cord 120 from retracting through the port 130 and into the housing 110.

The housing 110 may have, for example, a permanent or semi-permanent printed company logo or a sticker attached thereto. Such printed logos and attached stickers are essentially impossible or difficult to change once applied to a housing 110. Certain other ways of attaching, for example, a logo or decorative piece to a housing 110 may require modifications to the housing 110 and/or cumbersome attachment means built into the logo or decorative piece.

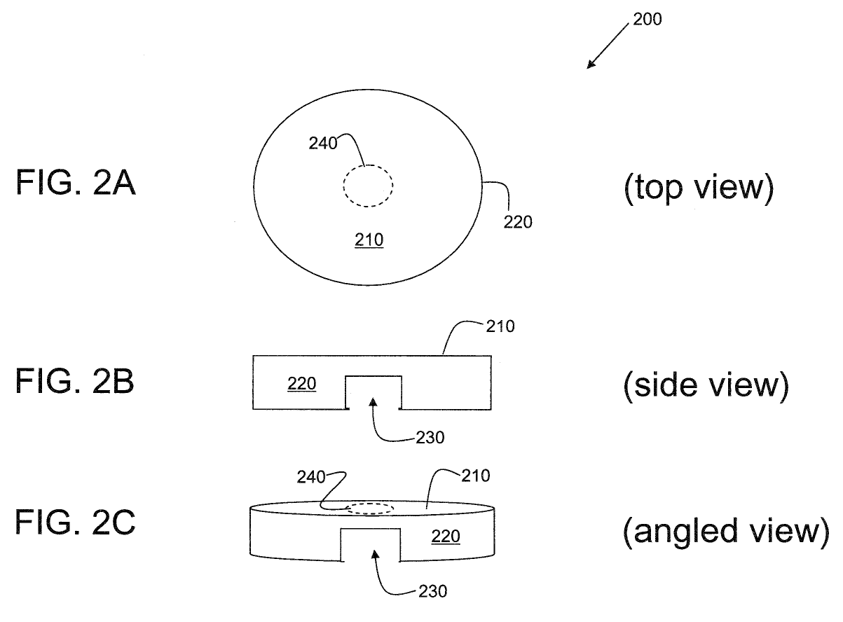

FIGS. 2A-2C illustrate an exemplary embodiment of a fitted cover or cap 200 for decoratively reconfiguring and protecting the retractable device 100 of FIG. 1. The fitted cover 200 is substantially cylindrical in shape and includes a substantially flat top portion 210 and a curved wall portion 220. A diameter and a height of the fitted cover 200 substantially match a diameter and a height of the substantially cylindrical housing 110 of the retractable device 100. The term “fitted” as applied to a cover or cap as described herein means that the cover or cap may be press-fitted onto a case or housing of a retractable device.

In accordance with an embodiment, the diameter of the fitted cover 200 is about 1.25 inches and the height of the fitted cover 200 is about 0.375 inches. The curved wall portion (rim) 220 of the fitted cover 200 includes a notch or slot 230 to accommodate a retractable cord 120 of the retractable device 100 there through. In accordance with an embodiment, a width of the notch is about 0.25 inches and a height of the notch is about 0.25 inches. As an option, the top portion 210 of the fitted cover 200 may include a hole or opening 240 for accommodating a decorative piece such as, for example, a Jibbitz® charm.

The fitted cover 200, when attached to a decorative piece, becomes a decorative and protective accessory that may be press-fitted onto the case 110 of the retractable device 100. A press-fit (sometimes known as an interference fit) is a fastening between two parts which is achieved by friction after the parts are pushed together, rather than by any other means of fastening.

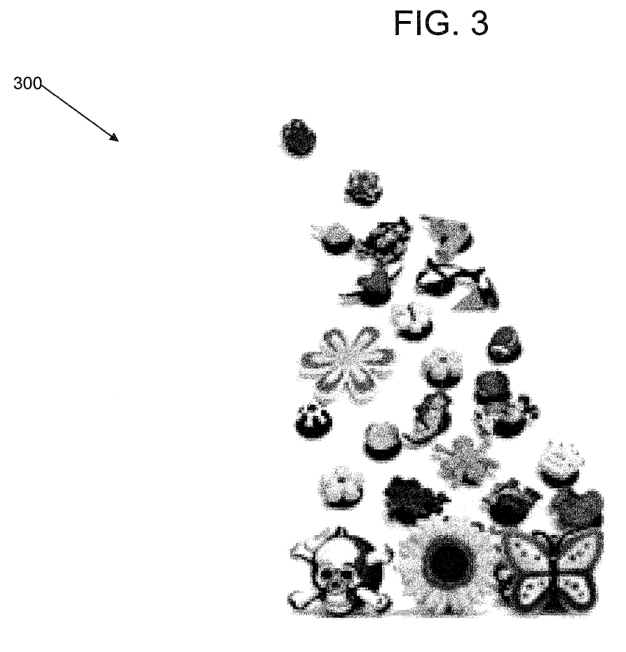

FIG. 3 illustrates exemplary embodiments of decorative pieces 300 that may be attached to the fitted cover or cap of FIGS. 2A-2C. A decorative piece may include one of a decorative button, a bubble sticker, a logo, an icon, a shoe-doodle™ charm, or a Jibbitz® charm, for example. Other types of decorative pieces are possible as well. One or more decorative pieces 300 may be attached to the exterior of the top portion 210 of the fitted cover 200 via an adhesive, for example.

As an alternative, a decorative piece 300 (e.g., a Jibbitz® charm) may be attached to the top portion 210 of the fitted cover 200 via the hole or opening 240. A tab or protrusion on the back side of the decorative piece (e.g., a Jibbitz® charm) is inserted through the opening 240 such that the tab or protrusion ends up just inside the fitted cover 200 while the decorative portion of the decorative piece 300 remains outside the fitted cover 200 and held in place by the tab or protrusion.

A decorative piece attached to a fitted cover serves as an accessory that may be worn by a user on the user's retractable device. Such a decorative accessory may be easily slipped on and off of the retractable device by the user such that a user may easily change the design, style, color, or theme to suit their taste or to accessorize their outfit. For example, certain decorative pieces may correspond to the logos or emblems of sports teams. Other decorative pieces may correspond to types of pets or breeds of dogs, for example.

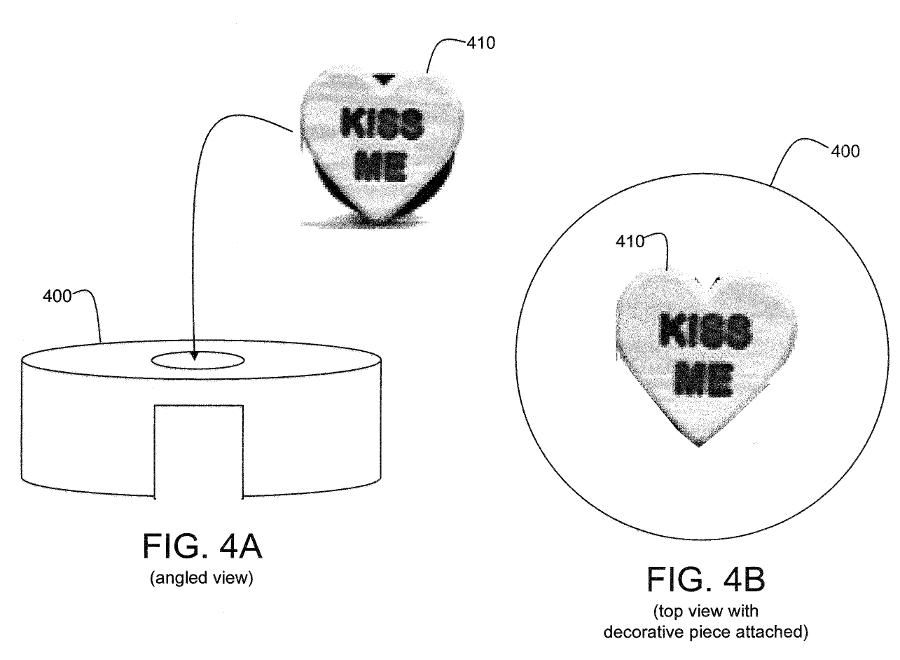

For example, FIGS. 4A-4B illustrate an exemplary embodiment of a decorative piece 410 (a Jibbitz® charm) being attached to a fitted cover 400. FIG. 4A shows an angled view with the decorative piece 410 not yet attached to the fitted cover 400. FIG. 4B shows a top view of the decorative piece 410 being attached to the fitted cover 400.

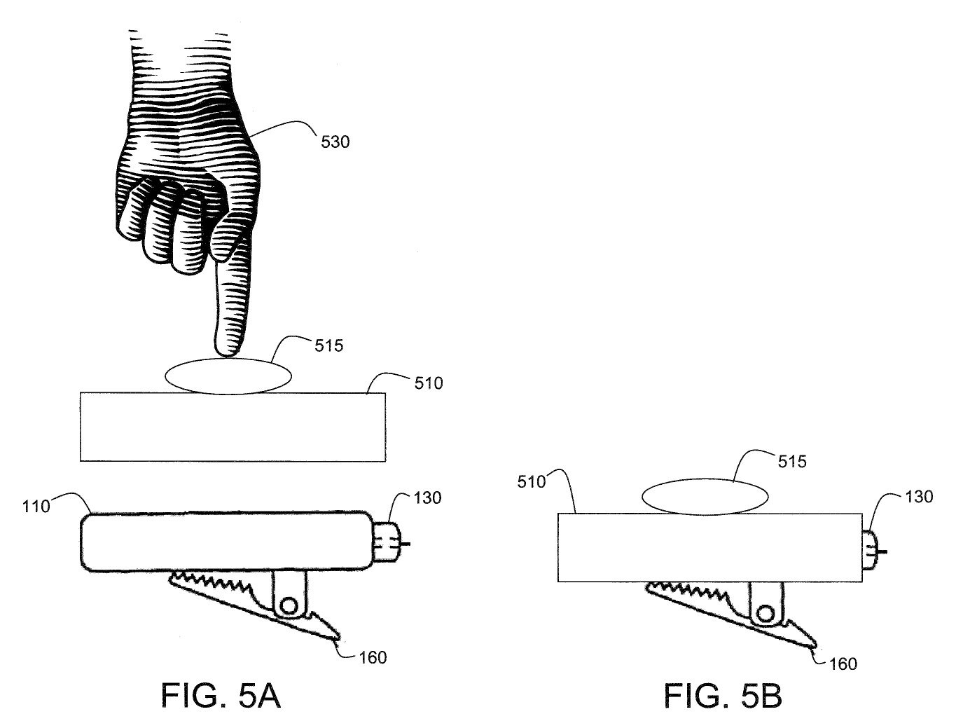

FIGS. 5A-5B illustrate an exemplary embodiment of a process for press-fitting a fitted cover or cap 510 onto a case 110 of the retractable device 100 of FIG. 1. The fitted cover or cap 510 includes a decorative piece 515 attached to a top portion of the fitted cover or cap 510. Again, the decorative piece 515 may include one of a decorative button, a bubble sticker, a logo, an icon, a shoe-doodle™ charm, or a Jibbitz® charm, for example. Other types of decorative pieces are possible as well. A user 530 simply presses the fitted cover 510 down onto the case 110 of the retractable device 100 as shown in FIG. 5A. FIG. 5B shows the decorative cap 510 press-fitted onto the case 110. A notch in the curved side of the fitted cover is aligned with the port 130 such that the port 130 does not interfere with press-fitting the fitted cover 510 onto the case 110.

In accordance with an embodiment, the fitted cover is made of a molded plastic material. The molded plastic material of the fitted cover allows the fitted cover to be press-fit onto the housing of the retractable device such that the fitted cover remains secured to the housing by frictional forces as the user goes about their daily activities. The frictional forces are such, however, that the user may easily remove the fitted cover and, for example, replace with another fitted cover having a different decorative piece attached thereto. Other materials, which also allow for a press-fit, are possible as well for the fitted cover.

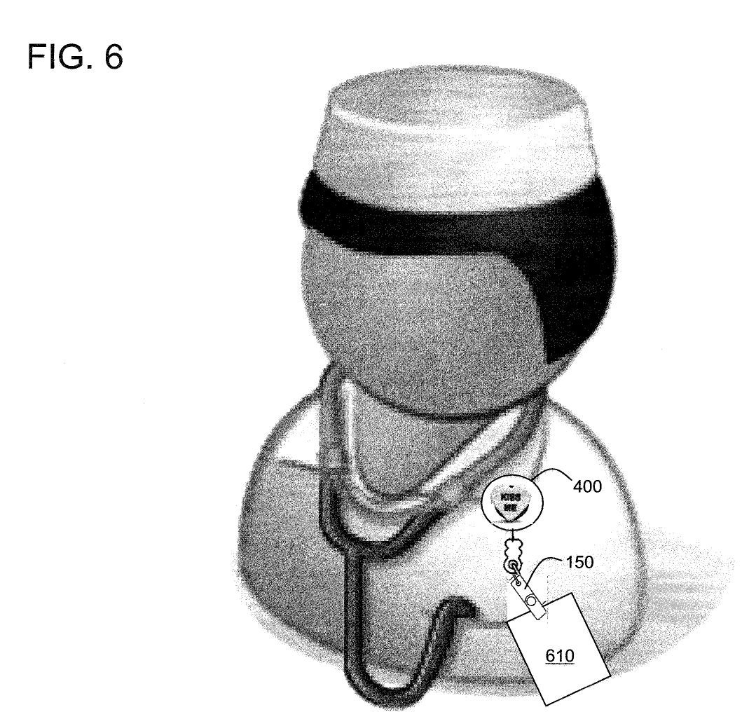

Once the decorative fitted cover 510 is press-fitted onto the case 110, the retractable device may be attached to, for example, a pocket, lapel, or belt of the user via a clip 160. For example, FIG. 6 illustrates an exemplary embodiment of a decorative fitted cover or cap 400 of FIGS. 4A-4B on a retractable badge reel 100 as worn by a nurse (i.e., a user). A badge 610 is attached to the retractable badge reel 100 via the securing unit 150 of the retractable badge reel 100. The badge 610 may serve to identify the nurse and to allow access to certain areas of a hospital, for example.

The press-fitted decorative cover 400 may be easily removed by the nurse by gripping the cover 400 with her fingers and sliding the cap 400 off of the case 110. The nurse may then easily press-fit a different cover or cap, having a different decorative piece thereon, onto the case 110 of the retractable device 100. The fitted cover 400 serves to decorate as well as protect the case 110 of the retractable device 100.

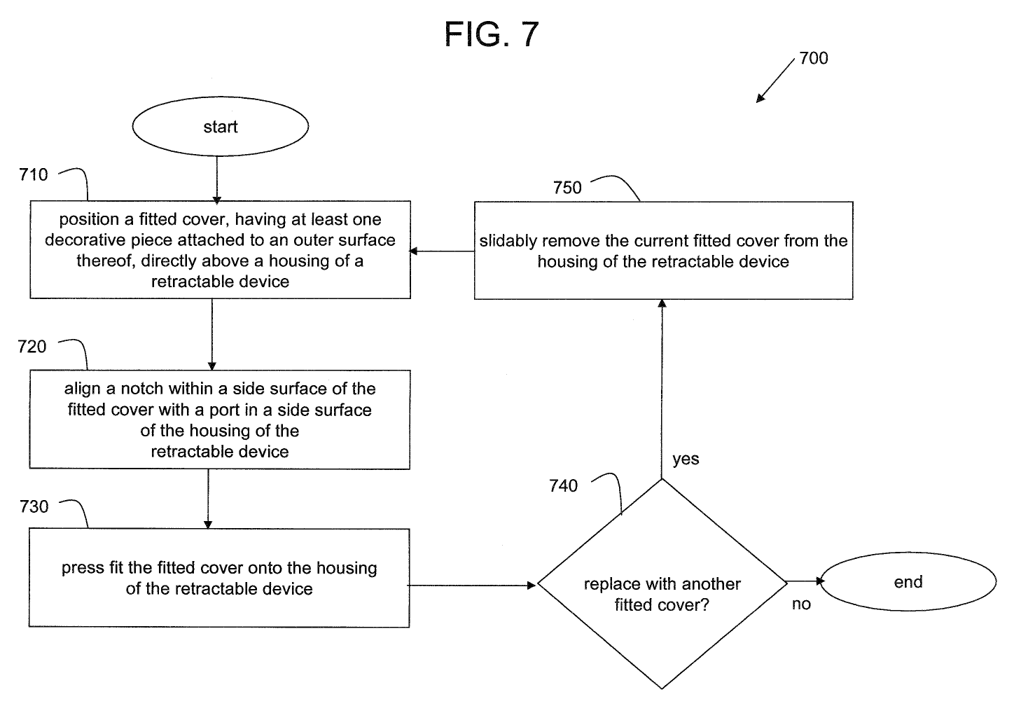

FIG. 7 is a flow chart of an exemplary embodiment of a method 700 of decoratively reconfiguring and protecting a retractable device. In step 710, position a fitted cover, having at least one decorative piece attached to an outer surface thereof, directly above a housing of a retractable device. In step 720, align a notch within a side surface of the fitted cover with a port in a side surface of the housing of the retractable device. In step 730, press-fit the fitted cover onto the housing of the retractable device. In step 740, a decision is made as to replace the fitted cover (or not) with another fitted cover having a different decorative piece attached thereto (i.e., reconfigure the retractable device?). If the decision in step 740 is yes, then in step 750, slidably remove the fitted cover from the housing of the retractable device and proceed to step 710 with the new fitted cover.

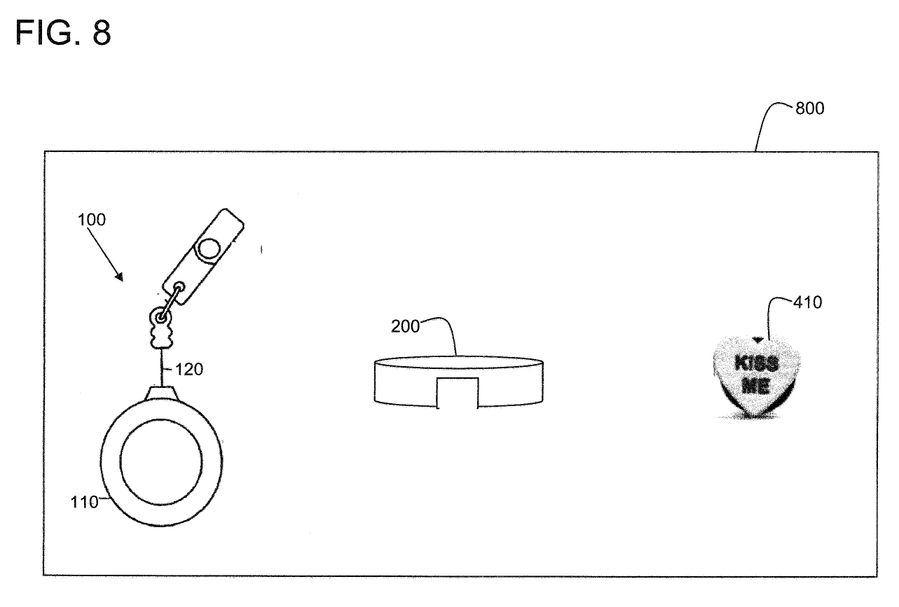

FIG. 8 illustrates a first exemplary embodiment of a kit 800. The kit 800 includes a retractable device 100 having a case 110 that houses a retractable cord 120. The kit 800 further includes at least one cap or fitted cover 200 capable of being press-fitted onto and subsequently removed from the case 110 of the retractable device 100 a plurality of times, at least until the cap 200 wears out or becomes too loose to maintain a press-fit to the case 110 during normal use. The kit 800 also includes at least one decorative piece 410 capable of being attached to the at least one cap 200.

A user of the kit may attach a decorative piece to the top surface of the cap 200 via, for example, an adhesive. The adhesive may be in the form of an adhesive strip on the top surface of the cap or on the bottom surface of the decorative piece. A protective cover may be removed from the adhesive strip such that the decorative piece may be applied to the top surface of the cap. Alternatively, a tube of liquid adhesive (e.g. super glue), which is applied by a user, may be provided as part of the kit 800. Other types of adhesives are possible as well. Alternatively, the decorative piece 400 may be a Jibbitz® charm and the cap 200 includes an opening in the top surface for insertion of the Jibbitz® charm as previously discussed herein. As a further alternative, a Velcro-type material may be applied to the top surface of the cap 200 and the bottom surface of the decorative piece 410, allowing the decorative piece 410 to be attached to the cap 200 by the user.

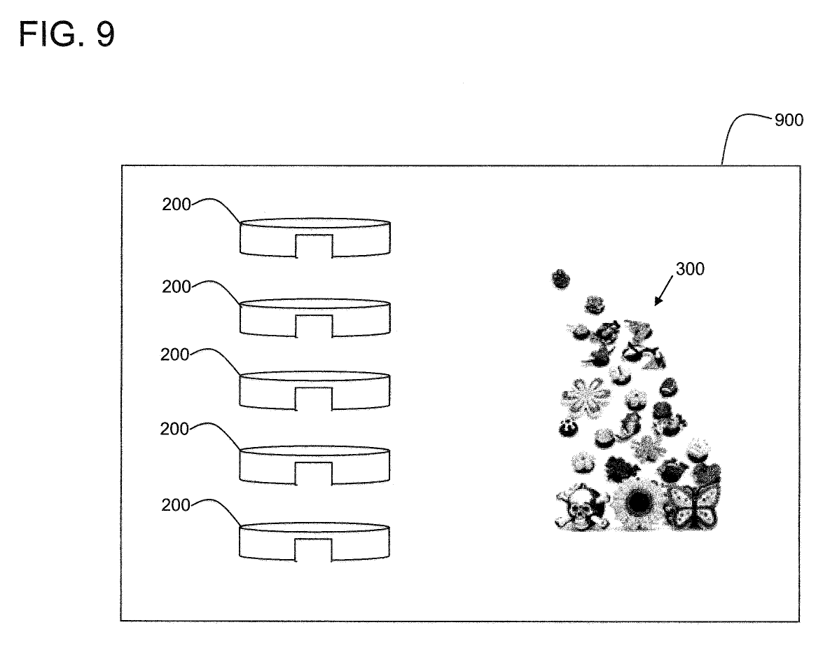

FIG. 9 illustrates a second exemplary embodiment of a kit 900. The kit 900 includes a plurality of fitted covers 200. Each fitted cover 200 is capable of being press-fitted onto and subsequently removed from a housing 110 of a retractable device 100 a plurality of times. The kit 900 also includes a plurality of decorative pieces 300. Each of the plurality of decorative pieces 300 is capable of being attached to any one of the plurality of fitted covers 200 by a user. Such a kit allows a user to create their own decorative accessory by choosing and attaching a decorative piece to a fitted cover 200.

Although exemplary embodiments of fitted covers and housings of retractable devices have been shown herein which are substantially cylindrical in shape, certain other embodiments may accommodate other shapes as well such as, for example, triangular shapes, rectangular shapes, and square shapes. Regardless of shape, the dimensions of the fitted cover substantially match the dimensions of the housing of the user-wearable device, at least in part, in order to provide an adequate press fit of the fitted cover onto the housing.

Furthermore, although exemplary embodiments of fitted covers herein refer to press fitting onto housings or cases of retractable devices, other applications may be possible as well. For example, the fitted covers described herein may possibly be applied to similarly shaped housings or cases of other user-wearable devices. Such other user-wearable devices may include, for example, a stethoscope or some other medical device that may be worn by a user.

In summary, kits, methods, and accessories for decoratively reconfiguring and protecting a user-wearable device are disclosed. One embodiment of a kit includes a retractable device having a case that houses a retractable cord, a cap capable of being press-fitted onto the case of the retractable device, and a decorative piece capable of being attached to the cap. One embodiment of a method includes positioning a fitted cover, having a first decorative piece attached to an outer surface thereof, directly above a housing of a retractable device, aligning a notch within a side surface of the fitted cover with a port in a side surface of the housing of the retractable device, and press-fitting the cover onto the housing of the retractable device. One embodiment of an accessory includes a fitted cover having a decorative piece and having a notch to accommodate a retractable cord of a retractable device there through.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A kit comprising:
a retractable device having a case that houses a retractable cord;
at least one cap capable of being press-fitted onto and subsequently removed from said case of said retractable device a plurality of times; and
at least one decorative piece capable of being attached to said at least one cap.

2. The kit of claim 1 wherein said retractable device comprises:
said case;
said retractable cord housed within said case;
a port within a side of said case for said retractable cord to pass through;
a bob connected to a proximal end of said retractable cord; and
a securing unit connected to said bob for securing a badge thereto.

3. The kit of claim 1 wherein said at least one cap is substantially cylindrical in shape, and wherein a diameter and a height of said substantially cylindrical cap substantially match a diameter and a height of said case of said retractable device, and wherein a side of said at least one cap includes a notch to accommodate said retractable cord of said retractable device there through.

4. The kit of claim 1 wherein said at least one decorative piece includes at least one of a decorative button, a bubble sticker, a logo, an icon, a shoe-doodle™ charm, and a Jibbitz® charm.

5. The kit of claim 3 wherein said at least one cap includes a top portion having an opening to accommodate insertion of a shoe-doodle™ charm or a Jibbitz® charm.

6. The kit of claim 1 wherein said at least one cap is made of a molded plastic material.

7. A kit comprising:
a plurality of fitted covers, each said fitted cover capable of being press-fitted onto and subsequently removed from a housing of a retractable device a plurality of times; and
a plurality of decorative pieces, each said decorative piece capable of being attached to any one of said plurality of fitted covers.

8. The kit of claim 7 wherein said retractable device comprises:
said housing;
a retractable cord housed within said housing;
a port within a side of said housing for said retractable cord to pass through;
a bob connected to a proximal end of said retractable cord;
and a securing unit connected to said bob for securing a badge thereto.

9. The kit of claim 8 wherein each of said plurality of fitted covers is substantially cylindrical in shape, and wherein a diameter and a height of each of said substantially cylindrical fitted covers substantially match a diameter and a height of said housing of said retractable device, and wherein a side of each of said fitted covers includes a notch to accommodate said retractable cord of said retractable device there through.

10. The kit of claim 7 wherein each of said plurality of decorative pieces includes one of a decorative button, a bubble sticker, a logo, an icon, a shoe-doodle™ charm, and a Jibbitz® charm.

11. The kit of claim 9 wherein at least one of said plurality of fitted covers includes a top portion having an opening to accommodate insertion of a shoe-doodle™ charm or a Jibbitz® charm.

12. The kit of claim 7 wherein each of said plurality of fitted covers is made of a molded plastic material.

13. A method of decoratively reconfiguring and protecting a retractable device, said method comprising:
positioning a first fitted cover, having at least a first decorative piece attached to an outer surface thereof, directly above a housing of said retractable device;
aligning a notch within a side surface of said first fitted cover with a port in a side surface of said housing of said retractable device; and
press-fitting said first fitted cover onto said housing of said retractable device.

14. The method of claim 13 further comprising:
slidably removing said first fitted cover from said housing of said retractable device;
positioning a second fitted cover, having at least a second decorative piece attached to an outer surface thereof, directly above said housing of said retractable device;
aligning a notch within a side surface of said second fitted cover with said port in said side surface of said housing of said retractable device; and
press-fitting said second fitted cover onto said housing of said retractable device.

15. The method of claim 14 wherein said first fitted cover and said second fitted cover are made of a molded plastic material.

16. A decorative and protective accessory for press-fitting onto a retractable device, said accessory comprising:
a substantially cylindrically shaped plastic cap including a substantially flat top portion having a diameter of about 1.25 inches and a curved wall portion having a height of about 0.375 inches;
at least one decorative piece attached to said top portion of said plastic cap; and
a notch within said curved wall portion of said plastic cap to accommodate a retractable cord of said retractable device there through, said notch being about 0.25 inches in width and about 0.25 inches in height.

17. The accessory of claim 16 wherein said at least one decorative piece includes one of a decorative button, a bubble sticker, a logo, an icon, a shoe-doodle™ charm, and a Jibbitz® charm.

18. A decorative and protective accessory for press-fitting onto a housing of a user-wearable device, said accessory comprising:
a fitted cover including a top portion and a wall portion, wherein dimensions of said fitted cover substantially match similar dimensions of said housing of said user-wearable device;
at least one decorative piece attached to said top portion of said fitted cover; and
at least one notch within said wall portion.

19. The accessory of claim 18 wherein said at least one decorative piece includes one of a decorative button, a bubble sticker, a logo, an icon, a shoe-doodle™ charm, and a Jibbitz® charm.

20. The accessory of claim 18 wherein said fitted cover is made of a molded plastic material.
